(19) United States
(12) Patent Application Publication
(10) Pub. No.: US 2006/0252610 A1
(43) Pub. Date: Nov. 9, 2006

(54) Method and apparatus for attaching a vibration unit to an exercise device

(75) Inventor: Jerry Wilson, Hillsboro, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignee: Soloflex, Inc.

(21) Appl. No.: 11/123,790

(22) Filed: May 6, 2005

(51) Int. Cl. A61H 1/02; A61H 7/00; A63B 21/00; A61H 1/00; A61H 19/00

(52) U.S. Cl. 482/92; 601/84; 601/5

(57) ABSTRACT

A vibration unit is attached to one side of a plate having an adhesive coating on its other side. The adhesive coating is protected until the vibration unit is to be attached to an exercise device. The protection is then removed and the plate is attached to a mating surface on the exercise device.

### CROSS REFERENCE TO RELATED APPLICATIONS

### BACKGROUND AND SUMMARY OF THE INVENTION

This invention relates to vibrating exercise devices, and in particular to the attachment of a vibrating unit to an existing exercise device.

Loss of bone density and slow healing of broken bones becomes a serious problem as people age. It is well known that exercise can slow down this process or prevent it from occurring. It also is becoming apparent that being exposed to vibration at specific frequency and amplitude ranges while exercising will increase the effectiveness of the exercise in this regard. As a result it is now becoming common to equip exercise devices with vibration units. However, vibration equipped exercise devices are expensive, particularly when someone already has a comparable device that is not vibration equipped.

The subject invention overcomes this by providing a vibration unit that can be attached to an existing exercise device and a method of doing this. The vibration unit is attached to one side of a plate and an adhesive is placed on the other side of the plate. The adhesive is protected until the vibration unit is ready to be attached to the exercise device. When it is desired to attach the vibration unit to the exercise device, the protection is removed from the adhesive and the plate is attached to a mating surface on the exercise device.

The foregoing and other objectives, features, and advantages of the invention will be more readily understood upon consideration of the following detailed description of the invention taken in conjunction with the accompanying drawings.

### BRIEF DESCRIPTION OF THE DRAWINGS

FIG. 1 is a side elevation view of a vibration unit embodying the subject invention.

FIGS. 3 and 4 are perspective views of resistance-type exercise devices with the vibration unit attached to them.

FIG. 5 is a perspective view of a weightlifting bench with the vibration unit attached to it.

FIG. 6 is a perspective view of a platform upon which exercises can be performed with the vibration unit attached to it.

### DETAILED DESCRIPTION OF A PREFERRED EMBODIMENT

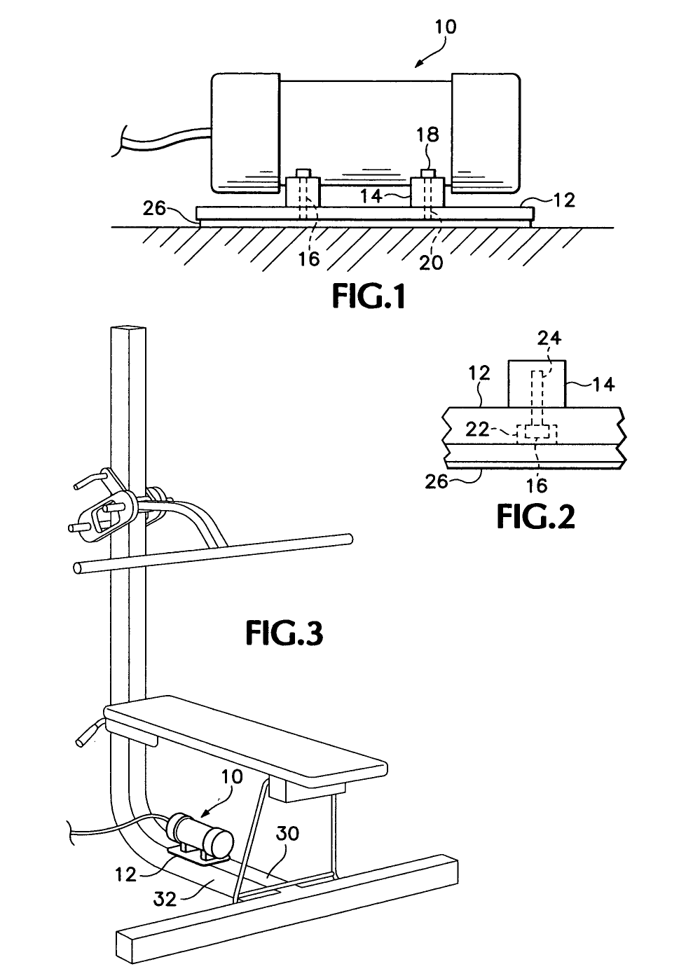

Referring now to FIG. 1 of the drawings, a vibration unit 10 is attached to one side of a plate 12. Vibration units of this type are commercially available from several sources. One such vibration unit is a double eccentric motor which is sold by Triem Inc. of Greensboro, N.C. This vibration unit is available as an AC powered unit or a battery powered unit. While the embodiment illustrated is AC powered, a battery powered unit would work as well. Vibration units of this type create low-amplitude vibration at the correct frequency and are used commercially in vibrating chairs, vibrating beds, and massagers. It is becoming common for exercise apparatus or exercise platforms to have such a vibrating unit integrally attached to them, in order to cause the exercise device to vibrate while exercises are being performed on it, in order to increase the benefit of the exercise in preventing bone loss. It has been found that this vibration is most effective in a frequency range between approximately 20 and 60 megahertz.

In the embodiment illustrated in the drawings, the plate 12 is flat, but it could have many other shapes as well, depending on the shape of the surface the plate will be attached to. The exercise unit illustrated has four projecting lugs 14 with openings 16 extending through them. Bolts 18 extend through the openings in the lugs into threaded holes 20 in the plate to attach the vibration unit to the plate. In another embodiment, shown in FIG. 2, the bolts 16 extend through countersunk openings 22 in the plate 12 into threaded holes 24 in the lugs 14. However, the vibration unit can be attached to the plate by any known fastening method.

Located on the other side of the plate 12 is an adhesive coating. In the embodiment illustrated the adhesive coating is a piece of double-sided tape 26 which is attached to the plate 12. The side of the tape 26 facing away from the vibration unit is protected so that it will not adhere to something it comes into contact with until it is desired to attach the vibration unit to an exercise device. With the double back tape illustrated in the drawings the protection is a removable sheet 28. Ways of providing an adhesive surface on the outer side of the plate 12 other than double back tape could be used. A spray-on adhesive is an example. While the removable sheet 24 shown in the drawings is not required, some way must be provided to temporarily protect the adhesive until the vibration unit is attached to an exercise device.

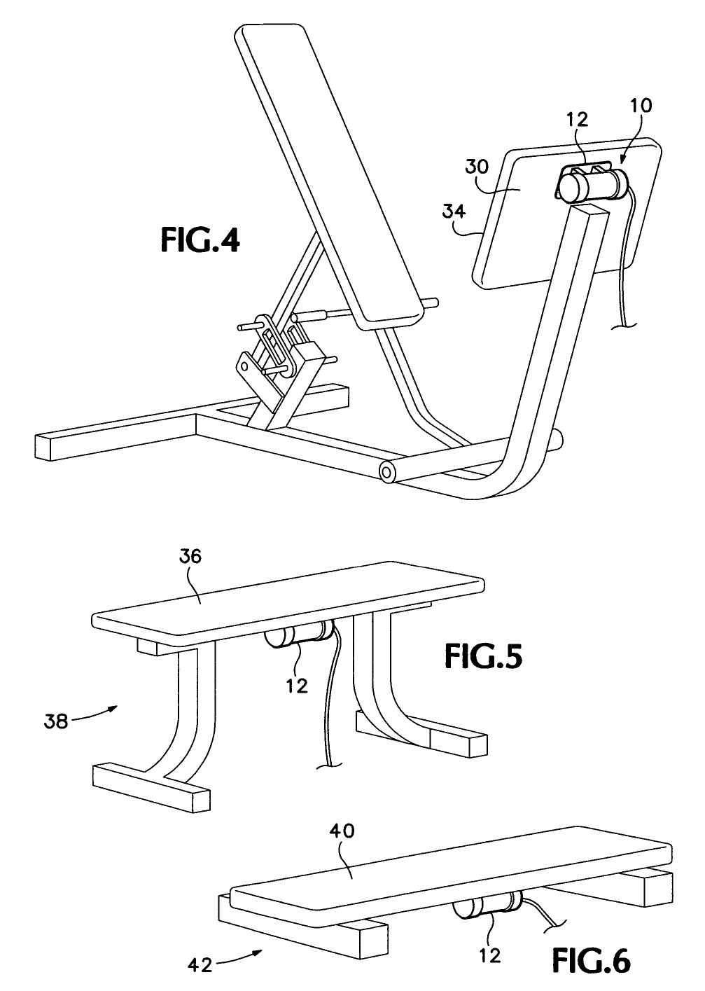

The vibration unit is easily attached to an exercise device by removing the sheet 28 from the double-back tape, or otherwise exposing the adhesive if double-back tape with a removable sheet is not used. The plate is then placed on a suitable surface 30 on the exercise device and the vibration unit is pushed toward the exercise device to adhere the adhesive to the surface 30. The best adhesion will occur when the plate 12 has the same shape as the surface 30 it is attached to, however, having conforming shapes is not essential. FIG. 3 shows the vibration unit 10 attached to the main frame 32 of a resistance-type weightlifting machine manufactured by applicant's assignee Soloflex, Inc. FIG. 4 shows the vibration unit 10 attached to the headrest 34 of another type of resistance exercise device sold by Soloflex under the ROCKIT trademark. FIG. 5 shows the vibration unit 10 attached to the underside of the table 36 of a weightlifting bench 38. FIG. 6 shows the exercise unit 12 attached to the underside of the platform 40 of a bench 42 that a user can stand or sit on while performing exercises. The use of the vibration unit is not limited to the exercise device as shown, but can be attached to any structure which a user performs exercises on to enhance the effect of the exercise in preventing bone loss.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. An apparatus for attaching a vibration unit to a device upon which exercises can be performed, comprising:
a. A plate;
b. means for attaching a vibration unit to said plate, on one side thereof;
c. an adhesive coating on an opposite side of said plate; and
d. means for protecting said adhesive coating until it is desired to attach said plate to a device for performing exercises.

2. The apparatus of claim 1 wherein the adhesive coating is a piece of double-sided tape.

3. The apparatus of claim 2 including a protective sheet which covers said adhesive coating, said protective sheet being configured to be easily removed from said adhesive coating without substantially reducing the adhesive effect of said adhesive coating;

4. An apparatus for attaching a vibration unit to a device upon which exercises can be performed, comprising:
a. a plate;
b. means for attaching a vibration unit to said plate;
c. a piece of tape which is adhered to said plate opposite said vibration unit;
d. said tape having an adhesive surface which faces outwardly from said plate; and
e. a protective sheet which covers said adhesive surface, said protective sheet being configured to be easily removed from said adhesive surface without substantially reducing the adhesive effect of said adhesive surface.

5. The apparatus of claim 4 wherein said plate is planar.

6. The apparatus of claim 4 wherein said vibration unit contains one or more threaded openings and said means for attaching comprises bolts which extend through holes in said plate and into said threaded openings in said vibration unit.

7. The apparatus of claim 4 wherein said vibration unit has lugs which have openings passing therethrough and said means for attaching comprises bolts which extend through said openings and into threaded holes in said plate.

8. The apparatus of claim 4 wherein said vibration unit vibrates at a frequency between approximately 20 and 60 megahertz.

9. The apparatus of claim 4 wherein said vibration unit is electrically powered.

10. A method for attaching a vibration unit to a device upon which exercises can be performed, comprising:
a. providing a vibration unit;
b. attaching said vibration unit to one side of a plate;
c. attaching an inward facing side of a piece of double-sided tape to the other side of said plate while leaving a protective sheet on an outward facing side of said tape; and
d. thereafter removing the protective sheet from said tape and affixing said tape to a mating surface on an exercise device.
